(19) United States
(12) Patent Application Publication
(10) Pub. No.: US 2015/0092580 A1
(43) Pub. Date: Apr. 2, 2015

(54) TRAFFIC MEASURING PERIOD CONTROL SYSTEM FOR MEASURING ENERGY OF ROUTER AND METHOD THEREFOR

(71) Applicant: Korea Advanced Institute of Science and Technology, Daejeon (KR)

(72) Inventors: Hong-shik Park, Daejeon (KR); Young-min Kim, Daejeon (KR); Eun-jung Lee, Daejeon (KR)

(21) Appl. No.: 14/389,717

(22) PCT Filed: Nov. 26, 2012
(86) PCT No.: PCT/KR2012/010041

§ 371 Date: Sep. 30, 2014

(30) Foreign Application Priority Data
Oct. 5, 2012 (KR) 10-2012-0110501

(51) Int. Cl. H04L 12/24; H04L 12/26; H04L 12/931

(52) U.S. Cl. CPC H04L 41/0833; H04L 49/501; H04L 43/10; H04L 43/0882
USPC 370/252

(57) ABSTRACT

Disclosed are a traffic measuring period control system for measuring energy of a router and a method therefor. The traffic measuring period control system comprises: a state measurement unit for measuring a traffic road or energy consumption of the router, and a measuring period setting unit for setting the traffic measuring period on the basis of the measured traffic load value and the measured energy consumption value, and the state measurement unit can measure the traffic load of the router according to the set traffic measuring period.

### FIELD OF THE INVENTION

The present invention relates to a traffic measuring period control system for measuring energy of a router and a method therefor that can efficiently measure energy consumed by the router and that can reduce the energy being consumed when measuring the traffic.

### BACKGROUND ART

Current networks tend to consume a larger amount of energy due to the management, maintenance, and product and service provision of IT (Information Technology) operations, and, between years 2000˜2005, the consumed amount of energy of IT-related industries have increased to up to approximately 3 times the previous amount. Additionally, based upon such tendencies, the amount of carbon dioxide discharge caused by the IT field in the future is estimated to amount to approximately 10˜15% of the global carbon dioxide discharge amount within the next several years. Therefore, it is imperative to make an active effort to reduce the amount of carbon dioxide discharge by reducing power consumption by having router devices, which configure the communication networks, efficiently measure its energy status.

In order to allow a router device to efficiently measure its energy status, information, such as traffic size or energy consumption amount, of a current router should be measured with minimum effort, so that energy reduction and massive traffic can be observed/managed. Currently, SNMP (Simple Network Management Protocol), CMIP (Command Management Information Protocol), and so on, exist for the status or control of router devices, and status information of networks are being managed by using such protocols. However, in case of the SNMP, it is disadvantageous in that, due to its consistent yet long measuring period of 5-minute units, the function of observing and managing massive traffic is weak, and, when energy is measured in accordance with this period, it is difficult to swiftly respond to the change in energy status.

Accordingly, a technique of collecting and checking traffic at shortened periods (or intervals), which are shorter than previous periods by shortening traffic measuring periods, within a range that does not burden the load of the checking equipment (or observation equipment), is proposed in the Korean Patent Application No. 10-2010-0045257 (Publication Date: May 3, 2010). However, such technique relates to applying shortened traffic measuring periods for performing detailed network collection and, therefore, merely relates to collecting traffic at consistent time periods, and, moreover, energy efficiency respective to traffic measurement is not considered in such technique. When traffic measuring periods are set to consistent intervals, network traffic is unnecessarily measured even when the traffic status is consistent, and, therefore, unnecessary energy consumption may be caused due to the traffic measurement.

Therefore, a device and method that can minimize the amount of energy being unnecessarily consumed when performing traffic measurement of the router, and that can more easily deduce energy consumption amount respective to traffic load are being required.

### DETAILED DESCRIPTION OF THE INVENTION

### Technical Objects

Provided herein are a traffic measuring period control system for measuring energy of a router and a method therefor that can minimize energy being unnecessarily consumed when measuring traffic of the router.

### Technical Solutions

In order to minimize the amount of energy being unnecessarily consumed when performing traffic measurement of the router, the present invention may control traffic measuring periods based upon status information, i.e., traffic load and energy consumption values.

A traffic measuring period control system according to the present invention includes a state measurement unit for measuring a traffic load value of a router; and a measuring period setting unit for setting the traffic measuring period on the basis of the measured traffic load value and the measured energy consumption value, and the state measurement unit can measure the traffic load of the router according to the set traffic measuring period.

The energy consumption value may correspond to a value measured by the state measurement unit, or the energy consumption value may correspond to a predetermined value within the system.

According to an aspect, the system further includes a network congestion notification unit for generating a network congestion notification, when the traffic load is equal to or greater than a predetermined threshold value, and, when the network congestion notification is generated, the measuring period setting unit may set the predetermined threshold value as the traffic measuring period.

According to another aspect, when the network congestion notification is not generated, the measuring period setting unit may compare the measured traffic load value and a traffic load value measured in a previous period, and, when the values are identical, the measuring period setting unit may set the traffic load value measured in a previous period as the traffic measuring period.

According to yet another aspect, the measuring period setting unit may include an energy profile model generating module for generating an energy profile model for estimating the energy consumption value by using the measured traffic load value and the maximum energy consumption value and the maximum traffic load value and a traffic measuring period setting module for setting the traffic measuring period based upon an inclination value of the energy profile model and the network congestion notification.

According to yet another aspect, the traffic measuring period setting module may set a value dividing a previous traffic measuring period by the inclination value as the traffic measuring period.

According to yet another aspect, when the inclination value is greater than a predetermined value, the traffic measuring period setting module may set a traffic measuring period to have a long interval, and, when the inclination value is smaller than a predetermined value, the traffic measuring period setting module may set a traffic measuring period to have a short interval.

According to a further aspect of the present invention, the system may further include a statistical model storage unit updating pre-stored statistical information based upon the measured traffic load value and an energy consumption value estimated by using the energy profile model.

A method of a traffic measuring period control system for controlling a traffic measuring period may include a step of measuring a traffic load of a router, a step of calculating an energy consumption rate of the router by using the measured traffic load value and the maximum energy consumption value of the router and maximum traffic load value of the router and setting a traffic measuring period based upon the calculated value and a step of measuring the traffic load of the router in accordance with the set traffic measuring period.

Another traffic measuring period control system according to the present invention includes a state management unit for measuring a traffic load value in accordance with a traffic load measuring period of a router, a measuring period setting unit for setting an energy profile model and the traffic measuring period by using a traffic load value measured by the state management unit, a maximum traffic load value and a maximum energy consumption value of the corresponding router, and a network congestion notification value, a statistical model storage unit for receiving and storing a traffic load value from the state management unit, and storing statistical information respective to an energy profile model from the measuring period setting unit, a network congestion state notification unit for providing the network congestion notification value to the measuring period setting unit, and a router basic information storage unit for providing a maximum energy consumption value and a maximum traffic load value to the measuring period setting unit.

Yet another traffic measuring period control system of the present invention includes a state management unit for measuring a traffic load value in accordance with a traffic measuring period of a router, a measuring period setting unit for generating an energy profile model and the traffic measuring period based upon the traffic load value and its respective energy consumption rate, and a storage unit for storing a traffic load statistical model and an energy statistical model based upon the measured energy consumption rate and the traffic load value.

### Effects of the Invention

By adjusting a traffic measuring period to have a long interval, when energy variance is small, and by adjusting a traffic measuring period to have a short interval, when energy variance is large, an overall number of measurement sessions may be reduced, thereby reducing the energy that is used for performing measurement.

For example, by efficiently adjusting a traffic measuring period based upon an inclination level of an energy profile model by using an energy consumption value, a consumed amount of energy respective to a traffic load may be easily deduced.

### BRIEF DESCRIPTION OF THE DRAWINGS

FIG. 1 illustrates a block view showing an energy profile based traffic measuring period control system according to an exemplary embodiment of the present invention.

FIG. 2 illustrates a flow chart showing a method for deducing an energy profile model according to an exemplary embodiment of the present invention.

FIG. 3 illustrates a flow chart showing an energy profile based traffic measuring period according to an exemplary embodiment of the present invention.

FIG. 4 illustrates a flow chart showing a detailed energy profile based energy consumption rate calculating method according to an exemplary embodiment of the present invention.

FIG. 5 illustrates a flow chart showing a traffic measuring period setting method by using an energy consumption value according to an exemplary embodiment of the present invention.

### MODE FOR CARRYING OUT THE PRESENT INVENTION

Objects and effects of the present invention, and technical configurations for achieving such objects and effects will become more apparent by referring to the exemplary embodiments, which will be described below along with the accompanying drawings. In describing the present invention, when it is determined that detailed description of disclosed functions or configurations may unnecessarily cause ambiguity in the essential features of the present invention, the detailed description of the same may be omitted. Additionally, the terms that will be mentioned below correspond to terms that have been defined based upon the functions of the present invention, and, therefore, such terms may be varied in accordance with the intentions or practice of the user and/or system operator.

However, the present invention will not be limited only to the exemplary embodiments that are disclosed below, and, therefore, the present invention may be realized in other diverse forms. Nevertheless, the exemplary embodiments are provided to complete the disclosure of the present invention and also to completely inform anyone skilled in the art of the technical scope of the present invention, and the present invention is merely defined by the scope and spirit of the appended claims. Therefore, the present invention shall be defined based upon the overall content of this specification.

Hereinafter, the exemplary embodiment of the present invention will be described in detail with reference to the accompanying drawings.

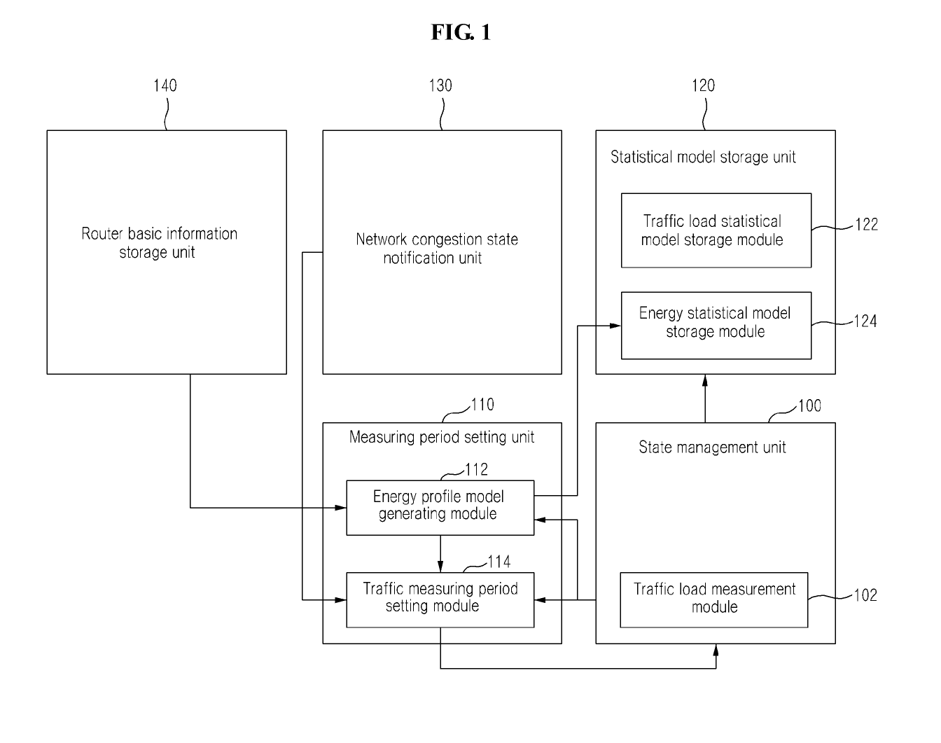

FIG. 1 illustrates a block view showing an energy profile based traffic measuring period control system according to an exemplary embodiment of the present invention. Referring to FIG. 1, the traffic measuring period control system may include a state management unit (100), a measuring period setting unit (110), a statistical model storage unit (120), a network congestion state notification unit (130), and a router basic information storage unit (140).

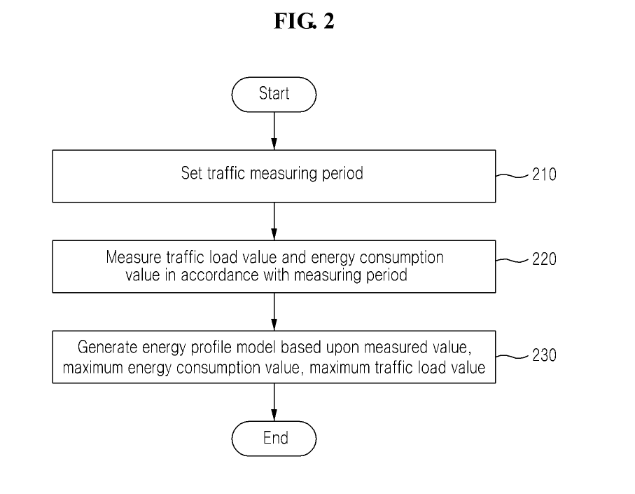

The state management unit (100) measures a state of a router, and, most particularly, the state management unit (100) measures a traffic load by including a traffic load measurement module (102), which measures traffic load of the router. The traffic load measurement module (102) measures the traffic load of the router in accordance with a predetermined traffic measuring period, and, then, the traffic load measurement module (102) provides the measured traffic load value to an energy profile model generating module (112) and a traffic measuring period setting module (114) of the measuring period setting unit (110). At this point, the traffic load value, which is measured by the traffic load measurement module (102), may be transmitted to the statistical model storage unit (120), so as to be stored in a traffic load statistical model storage module (122). Meanwhile, the energy profile model generating module (112) defines an energy consumption according to the traffic load value, which is measured by the traffic load measurement module (102), as an energy profile model, and the energy profile model generating module (112) performs a role of storing the energy profile model. A method for deducing the energy profile model will hereinafter be described in more detail with reference to FIG. 2.

In case the predetermined traffic measuring period is controlled by the measuring period setting unit (110), the state management unit (100) may measure traffic load in accordance with the controlled traffic measuring period.

Additionally, the energy profile model generating module (112) may deduce normalized traffic load value and energy consumption value, which are used for configuring the energy profile model, by using a maximum traffic load, a maximum energy consumption value, a traffic load value (pₜ), and an energy consumption value (eₚ), which are provided by the router basic information storage unit (140). At this point, in case the energy profile model exists by being provided by the router basic information storage unit (140), a current energy consumption value may be estimated based upon a current traffic load value, which is provided by the traffic load measurement module (102) of the state management unit (100), and the estimated current energy consumption value may be transmitted to the energy statistical model storage module (124) of the statistical model storage unit (120).

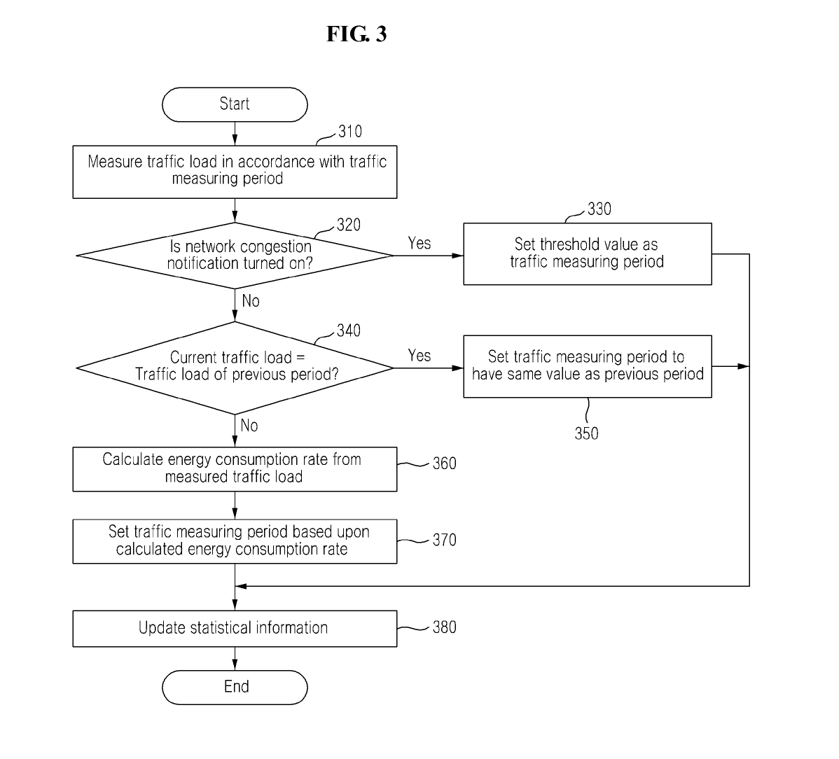

The traffic measuring period setting module (114) sets up a traffic measuring period by using a current energy consumption value, which is estimated by the energy profile model generating module (112), and a traffic load value, which is transmitted from the traffic load measurement module (102), a network congestion notification value, which is transmitted from the network congestion state notification unit (130), and a maximum energy consumption value and a maximum traffic load value, which are transmitted from the router basic information storage unit (140). The method for setting the traffic measuring period will hereinafter be described in detail with reference to FIG. 3.

The statistical model storage unit (120) may include a traffic load statistical model storage module (122), which stores statistical information of the traffic load value, and an energy statistical model storage module (124), which stores statistical information respective to the energy consumption value.

The traffic load statistical model storage module (122) updates the statistical information based upon the traffic load value, which is measured by the traffic load measurement module (102) of the state management unit (100) and the currently stored traffic load statistical value (e.g., average and standard deviation values).

The energy statistical model storage module (124) updates the statistical information based upon statistical information (e.g., average and standard deviation values) of the energy consumption value, which is indirectly measured from the energy profile model of the energy profile model generating module (112) of the measuring period setting unit (110), and the currently stored energy consumption value.

In case the traffic load of the router is greater than or equal to a threshold value, by generating a network congestion notification, the network congestion state notification unit (130) may set the traffic measuring period setting module (114) of the measuring period setting unit (110), so that the network congestion can be on.

The router basic information storage unit (140) may store basic information carried by the router or may store information, which is provided through an MIB (Management Information Base) field of a SNMP (Simple Network Management Protocol). The router basic information storage unit (140) may deliver the maximum energy consumption value, the maximum traffic load value, and the energy profile model to the energy profile model generating module (112) of the measuring period setting unit (110).

Meanwhile, the energy profile module may be deduced by using a static method and a dynamic method. First of all, the static method may correspond to a method of providing the energy profile module from the MIB (Management Information Base) field of the SNMP (Simple Network Management Protocol) or, since a value is stored within the system itself, the static method may correspond to a method of directly applying the stored value. Subsequently, as the dynamic method, as shown in FIG. 2, the energy profile model may be deduced by performing measuring (or measurement).

As a system using the above-described static method, in the above-described energy profile based traffic measuring period control system of FIG. 1, although a basic configuration generating an energy profile model by using an estimated energy consumption value (eₚ), which is estimated by using the energy profile model provided from the router basic information storage unit (140), instead of providing an energy consumption value (eₚ) from the state management unit (100), has been described above, as a dynamic method, the state management unit (100) may also measure the energy consumption value (eₚ). This process is described in detail with reference to FIG. 2.

First of all, FIG. 2 illustrates a flow chart showing a method for deducing an energy profile model, in case the energy consumption value (eₚ) is measured by the state management unit (100), according to an exemplary embodiment of the present invention.

Each process step of the above-described method for deducing an energy profile model according to the exemplary embodiment of the present invention may be respectively performed by each of the above-described state management unit (100) and the measuring period setting unit (110).

First of all, when the measuring period setting unit (110) sets a traffic measuring period (Tₚ) as T (210), the traffic load measurement module (102) of the state management unit (100) measures a traffic load value (pₜ) and an energy consumption value (eₚ) of the router in accordance with a measuring period (T), which is set up by the measuring period setting unit (110) (220).

Thereafter, the state management unit (100) transmits the measured traffic load value and energy consumption value to the energy profile model generating module (112) of the measuring period setting unit (110), and the router basic information storage unit (140) transmits the maximum energy consumption value (eₘₐₓ) and the maximum traffic load value (pₘₐₓ) to the energy profile model generating module (112) of the measuring period setting unit (110).

After changing Equation 1 shown below to a normalized value by using the maximum energy consumption value (eₘₐₓ), the maximum traffic load value (pₘₐₓ), the traffic load value (pₜ), and the energy consumption value (eₚ), the energy profile model generating module (112) applies the changed result to the deduction of an energy profile model (230).

pₙₒᵣ=pₜ/pₘₐₓ

eₙₒᵣ=eₜ/eₘₐₓ Equation 1

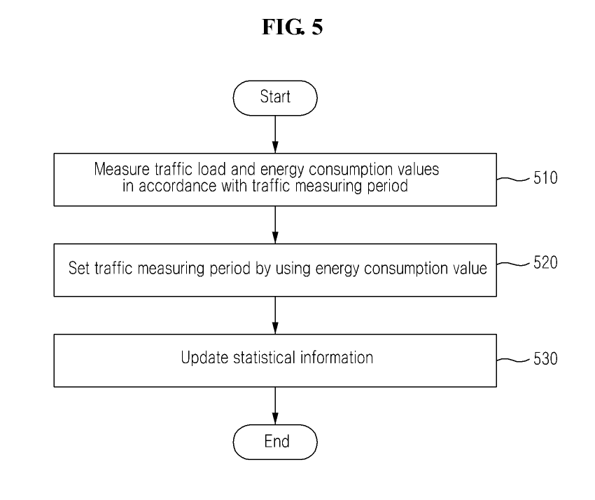

FIG. 3 illustrates a flow chart showing an energy profile based traffic measuring period according to an exemplary embodiment of the present invention. This drawing may be carried out as an example of the traffic measuring period setting method using the energy consumption value of FIG. 5.

Each process step of the energy profile based traffic measuring period according to the exemplary embodiment of the present invention may be respectively performed by each of the above-described state management unit (100), measuring period setting unit (110), statistical model storage unit (120), network congestion state notification unit (130), and router basic information storage unit (140).

First of all, the traffic load measurement module (102) of the state management unit (100) measures a traffic load (pₜ) in accordance with a predetermined traffic measuring period (310). Thereafter, the traffic load measurement module (102) transmits the measured traffic load value to the traffic measuring period setting module (114) of the measuring period setting unit (110). At this point, the traffic load measurement module (102) may transmit the measured traffic load value to the traffic load statistical model storage module (122) of the statistical model storage unit (120).

Thereafter, when the router basic information storage unit (140) transmits the maximum energy consumption value (eₘₐₓ) and the maximum traffic load value) (pₘₐₓ) to the measuring period setting unit (110), the measuring period setting unit (110) determines whether or not network congestion notification is turned on (320). At this point, in case the network congestion notification is turned on, the measuring period setting unit (110) sets the traffic measuring period (Tₚ) as a predetermined threshold value (Tₘᵢₙ) (330). However, in case the network congestion notification is not turned on, first of all, in order to avoid measuring the energy once again at the same traffic load, the measuring period setting unit (110) determines whether or not the current traffic load (pₜ) corresponds to the same value as the traffic load (pₜ₋₁) of a previous traffic measuring period (340). At this point, in case the current traffic load (pₜ) corresponds to the same value as the traffic load (pₜ₋₁) of a previous traffic measuring period, the measuring period setting unit (110) may set the traffic measuring period (Tₚ) to have the same value as the previous traffic measuring period (Tₘᵢₙ) (350).

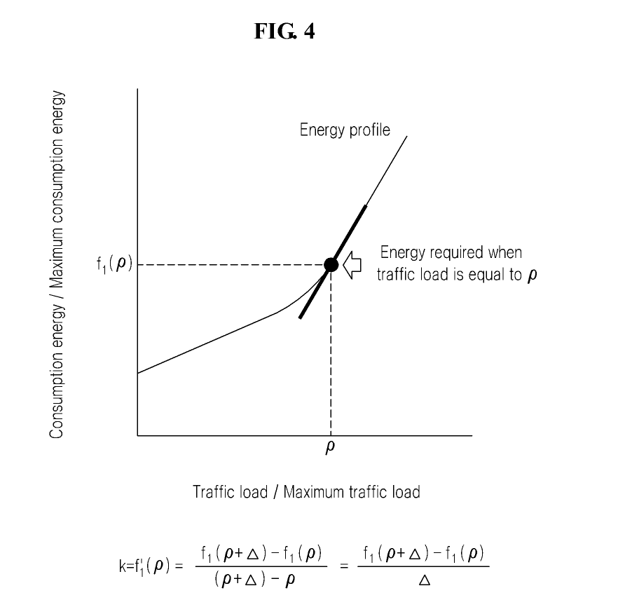

However, in case the current traffic load (pₜ) does not correspond to the same value as the traffic load (pₜ₋₁) of a previous traffic measuring period, the measuring period setting unit (110) calculates an inclination value (k) from the normalized traffic load value, which is calculated by the energy profile model generating module (112) by using Equation 1 shown above (360). At this point, the inclination value of the energy profile model signifies an energy consumption rate. The inclination value will be described in more detail later on with reference to FIG. 4.

Hereinafter, the measuring period setting unit (110) sets the traffic measuring period by using the calculated energy consumption rate (k) (370). Herein, the newly set traffic measuring period (Tₚ) may be set to a value dividing the basic traffic measuring period (T) by the energy consumption rate as shown below in Equation 2.

Tₚ=T:k Equation 2

Thereafter, the measuring period setting unit (110) estimates an energy consumption value corresponding to the normalized traffic load value, which is calculated based upon the energy profile model, and, then, the measuring period setting unit (110) may transmit the estimated value to the energy statistical model storage module (124) of the statistical model storage unit (120). Accordingly, the energy statistical model storage module (124) of the statistical model storage unit (120) may update the energy statistical information based upon the received energy consumption value (380).

FIG. 4 illustrates a flow chart showing a detailed energy profile based energy consumption rate calculating method according to an exemplary embodiment of the present invention.

As shown in FIG. 4, the energy profile model corresponds to a function having a normalized traffic load as its horizontal axis and having a normalized energy consumption value as its vertical axis. At this point, the normalized values may be calculated by the Equation 1 shown above.

For example, when the energy profile model is defined as

fₜ(p),

a normalized energy consumption value corresponding to a case when the normalized traffic load is equal to p may be equal to

fₜ(p), and

when the inclination in this case is defined as k, the inclination k may be calculated by using a first derivation value of the energy profile model, and this may be calculated by using Equation 3 shown below.

$$\begin{matrix}k = {f}_{l}^{′} ( ρ ) \\ = \frac{{f}_{l} ( ρ + Δ ) - {f}_{l} ( ρ )}{( ρ + Δ ) - ρ} \\ = \frac{{f}_{l} ( ρ + Δ ) - {f}_{l} ( ρ )}{Δ}\end{matrix} \qquad Equation 3$$

Herein, Δ signifies a unit traffic load (e.g., 0.01).

FIG. 5 illustrates a flow chart showing a traffic measuring period setting method by using an energy consumption value according to an exemplary embodiment of the present invention.

Each process step of the traffic measuring period setting method by using the energy consumption value according to the exemplary embodiment of the present invention may be respectively performed by each of the above-described state management unit (100), measuring period setting unit (110), and statistical model storage unit (120).

First of all, the traffic load measurement module (102) of the state management unit (100) measures a traffic load (pₜ) or energy consumption value in accordance with a predetermined traffic measuring period (510). Thereafter, the traffic load measurement module (102) transmits the measured traffic load value to the traffic measuring period setting module (114) of the measuring period setting unit (110). At this point, the traffic load measurement module (102) may transmit the measured traffic load value to the traffic load statistical model storage module (122) of the statistical model storage unit (120).

Subsequently, the measuring period setting unit (110) set the traffic measuring period by using the measured traffic load value and the energy consumption value, which is deduced by using the energy profile model, or the measured energy consumption value (520). At this point, the method of FIG. 3 may be used as an example of setting the traffic measuring period by using the energy consumption value.

Thereafter, the energy statistical model storage module (124) of the statistical model storage unit (120) may update energy statistical information based upon the received energy consumption value, and the traffic load statistical model storage module (122) may update traffic load statistical information based upon the received traffic load value (530).

Accordingly, by adjusting a traffic measuring period to have a long interval, when energy variance is small, and by adjusting a traffic measuring period to have a short interval, when energy variance is large, based upon the energy profile model, the traffic measuring period control system for measuring energy of a router and the method therefor may reduce an overall number of measurement sessions may be reduced, thereby reducing the energy that is used for performing measurement, and by doing so, the energy consumption amount respective to the traffic load may be easily deduced.

As described above, although the present invention has been described based upon limited exemplary embodiments and the accompanying drawings, the present invention will not be limited only to the above-described exemplary embodiments of the present invention, and, therefore, anyone skilled in the art may diversely correct and modify the present invention from the description provided above.

Therefore, the scope of the present invention should not be decided solely based upon the exemplary embodiments described above, and the scope of the present invention shall be decided based upon the appended claims that will hereinafter be described as well as the equivalents of the appended claims.

### INDUSTRIAL APPLICABILITY

The present invention may be applied to a system for controlling traffic measuring periods for measuring energy of a router.

1. A traffic measuring period control system, comprising:
a state measurement unit for measuring a traffic load value of a router; and
a measuring period setting unit for setting the traffic measuring period on the basis of the measured traffic load value and the measured energy consumption value, and
wherein the state measurement unit can measure the traffic load of the router according to the set traffic measuring period.

2. The system of claim 1, wherein the energy consumption value corresponds to a value measured by the state measurement unit, or wherein the energy consumption value corresponds to a predetermined value within the system.

3. The system of claim 2, further comprising:
a network congestion notification unit for generating a network congestion notification, when the traffic load is equal to or greater than a predetermined threshold value, and
wherein, when the network congestion notification is generated, the measuring period setting unit sets the predetermined threshold value as the traffic measuring period.

4. The system of claim 2, wherein, when the network congestion notification is not generated, the measuring period setting unit compares the measured traffic load value and a traffic load value measured in a previous period, and, wherein, when the values are identical, the measuring period setting unit sets the traffic load value measured in a previous period as the traffic measuring period.

5. The system of claim 2, wherein the measuring period setting unit comprises:
an energy profile model generating module for generating an energy profile model for estimating the energy consumption value by using the measured traffic load value and the maximum energy consumption value and the maximum traffic load value; and
a traffic measuring period setting module for setting the traffic measuring period based upon an inclination value of the energy profile model and the network congestion notification.

6. The system of claim 4, wherein the traffic measuring period setting module sets a value dividing a previous traffic measuring period by the inclination value as the traffic measuring period.

7. The system of claim 4, wherein, when the inclination value is greater than a predetermined value, the traffic measuring period setting module sets a traffic measuring period to have a long interval, and wherein, when the inclination value is smaller than a predetermined value, the traffic measuring period setting module sets a traffic measuring period to have a short interval.

8. The system of claim 4, further comprising:
a statistical model storage unit updating pre-stored statistical information based upon the measured traffic load value and an energy consumption value estimated by using the energy profile model.

9. As a method of a traffic measuring period control system for controlling a traffic measuring period, the traffic measuring period control method comprises:
a step of measuring a traffic load of a router;
a step of calculating an energy consumption rate of the router by using the measured traffic load value and the maximum energy consumption value of the router and maximum traffic load value of the router and setting a traffic measuring period based upon the calculated value; and
a step of measuring the traffic load of the router in accordance with the set traffic measuring period.

10. The method of claim 9, wherein, after the step of measuring a traffic load of a router, the method further comprises:
a step of determining whether or not the traffic load is greater than or equal to a predetermined threshold value; and
a step of generating a network congestion notification, when the traffic load is greater than or equal to the predetermined threshold value

11. The method of claim 10, wherein, when the network congestion notification is generated, the step of setting a traffic measuring period corresponds to a step of setting the predetermined threshold value as the traffic measuring period.

12. The method of claim 10, wherein, when the network congestion notification is not generated, the step of setting a traffic measuring period corresponds to a step of comparing the measured traffic load value and a traffic load value measured in a previous period, and, when the values are identical, setting the traffic load value measured in a previous period as the traffic measuring period.

13. The method of claim 10, wherein the step of setting a traffic measuring period comprises:
a step of generating an energy profile model for estimating the energy consumption value by using the measured traffic load value and the maximum energy consumption value and the maximum traffic load value; and
a step of controlling the traffic measuring period based upon an inclination value of the energy profile model and the network congestion notification.

14. The method of claim 13, wherein the step of setting a traffic measuring period corresponds to a step of setting a value dividing a previous traffic measuring period by the inclination value as the traffic measuring period.

15. The method of claim 13, wherein the step of setting a traffic measuring period corresponds to as step of setting a traffic measuring period to have a long interval, when the inclination value is greater than a predetermined value, and setting a traffic measuring period to have a short interval, when the inclination value is smaller than a predetermined value.

16. The method of claim 13, further comprising, after the step of measuring a traffic load of a router:
a step of updating pre-stored statistical information based upon the measured traffic load value and an energy consumption value estimated by using the energy profile model.

17. A traffic measuring period control system, comprising:
a state management unit for measuring a traffic load value in accordance with a traffic load measuring period of a router,
a measuring period setting unit for setting an energy profile model and the traffic measuring period by using a traffic load value measured by the state management unit, a maximum traffic load value and a maximum energy consumption value of the corresponding router, and a network congestion notification value,
a statistical model storage unit for receiving and storing a traffic load value from the state management unit, and storing statistical information respective to an energy profile model from the measuring period setting unit,
a network congestion state notification unit for providing the network congestion notification value to the measuring period setting unit, and
a router basic information storage unit for providing a maximum energy consumption value and a maximum traffic load value to the measuring period setting unit.

18. The system of claim 17, wherein the measuring period setting unit comprises:
a traffic measuring period setting module for setting a traffic measuring period by receiving the traffic load value, network congestion notification value, and energy profile model, and transmitting the set traffic measuring period to the state management unit.

19. The system of claim 18, wherein the measuring period setting unit comprises:
an energy profile model generating module for generating the energy profile model by receiving the traffic load value, and a maximum traffic load value and a maximum energy consumption value of the corresponding router, and transmitting the generated energy profile model to the traffic measuring period setting module and the statistical model storage unit.

20. The system of claim 17, wherein the energy profile model indicates an energy variance respective to a change in traffic, and wherein the measuring period setting unit controls the traffic load measuring period in accordance with the energy variance.

21-24. (canceled)
